(19) United States
(12) Patent Application Publication
(10) Pub. No.: US 2004/0258913 A1
(43) Pub. Date: Dec. 23, 2004

(54) Waveguides and methods to manufacture waveguides

(76) Inventor: Daoqiang Lu, Chandler, AZ (US)

Correspondence Address: GROSSMAN & FLIGHT, LLC, 20 N. WACKER DRIVE, SUITE 4220, CHICAGO, IL, 60606, US

(21) Appl. No.: 10/465,218

(22) Filed: Jun. 19, 2003

(51) Int. Cl. B32B 31/20; G02B 6/00

(52) U.S. Cl. 428/375; 156/309.9; 156/307.5; 385/15

(57) ABSTRACT

Waveguide assemblies and methods to manufacture waveguide assemblies are disclosed. An example method of manufacturing a waveguide assembly comprises: coating a surface of a waveguide with an adhesive layer; heating a substrate to a temperature above a melting point of the adhesive layer; placing the waveguide on the heated substrate when the adhesive layer is solid or semi-solid; and curing the adhesive layer.

### FIELD OF THE DISCLOSURE

This disclosure relates generally to optical waveguides, and, more particularly, to waveguides and methods to manufacture waveguides.

### BACKGROUND

Waveguides are frequently mounted on substrates such as printed circuit boards, package substrates, etc. to create waveguide assemblies. To reduce costs, it is desirable to manufacture waveguide assemblies using high volume manufacturing techniques. For example, it is known to begin the manufacturing process by etching, layering, or otherwise forming a plurality of waveguides in a waveguide sheet. After the sheet is constructed, it is cut or otherwise processed to separate some or all of the waveguides into discrete components of desired dimensions and geometries. The waveguides may then be further processed by, for example, laser cutting to form mirrors, etc.

Once the processing of the waveguides is complete, they are frequently mounted to substrates as mentioned above. In prior art methods, a waveguide may be mounted to a substrate by applying liquid adhesive to one or both of the waveguide and the substrate and manually positioning the waveguide at the desired location of the substrate. Unfortunately, because of its relatively low viscosity, liquid adhesive has a tendency to spread when compressed between two objects such as a waveguide and a substrate. In some instances, the liquid adhesive may spread too much such that it accidentally covers other structures. For example, the spreading adhesive may cover nearby solder pads on the substrate thereby making it difficult to solder structures to the pads later in the manufacturing process. Additionally, liquid adhesive may permit undesirable and/or accidental relative movement between the waveguide and the substrate after placement of the waveguide and prior to solidification of the adhesive. Such relative movements can result in misalignment between optical elements which may result in a reduction in optical transmission efficiency as well as other positional related problems.

One way to eliminate the problems associated with using liquid adhesive to secure a waveguide to a substrate is to eliminate the securement process altogether by, for example, using a waveguide integrated in a substrate. However, integrating waveguides into substrates typically complicates the manufacturing process.

It is known to create wafer-level underfill by using solutions of solvents, solid epoxies, and hardeners. In this approach, a wafer is spin coated with the solution. Spin coating is a known process wherein a wafer is placed on a wheel or drum and a puddle of the coating solution is placed in the center of the wafer. The wheel or drum is then spun at a high rate of speed (e.g., 3000 RPM) such that the coating solution spreads outward from the center of the wafer to coat the wafer with a thin film of the solution. The coated wafer is then removed from the wheel or drum. After the solvent of the solution is vaporized from the wafer, a solid underfill layer is left behind on the wafer. The wafer, with the attached solid underfill layer, may then be diced and otherwise processed as desired.

### BRIEF DESCRIPTION OF THE DRAWINGS

FIG. 1 is a schematic, cross-sectional illustration of an example waveguide.

FIG. 2 is a view similar to FIG. 1, but showing the example waveguide coated with an example adhesive solution.

FIG. 3 is a view similar to FIG. 2, but showing the example waveguide after the adhesive solution has solidified to form an adhesive film layer.

FIG. 4 is a view similar to FIG. 3, but showing the waveguide after being cleaved to form a mirror surface.

FIG. 5 is a schematic illustration showing the waveguide of FIGS. 1-4 mounted on an example substrate adjacent an example solder pad.

### DETAILED DESCRIPTION

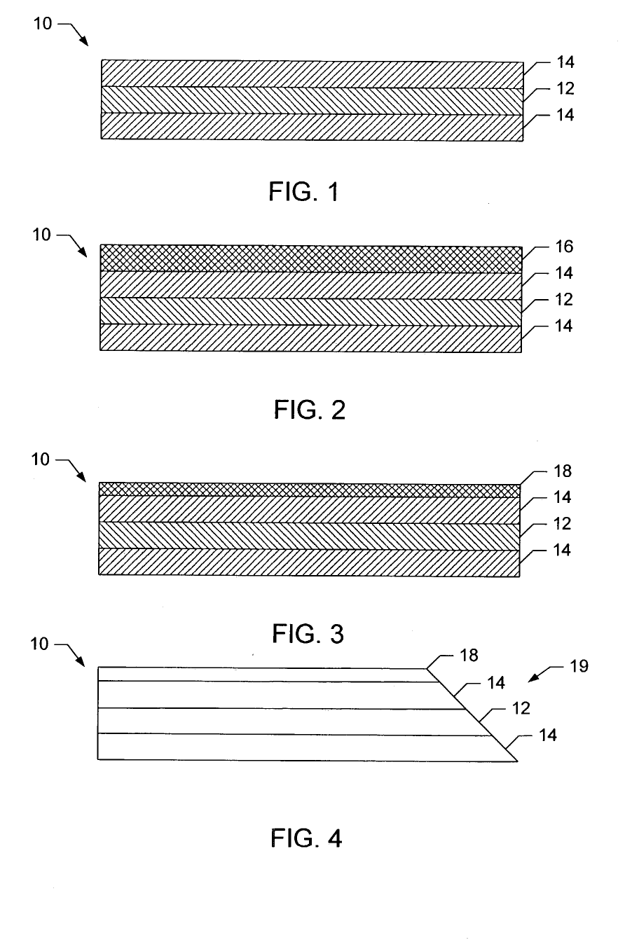

FIG. 1 is a schematic illustration of an example waveguide 10. As is conventional, the waveguide 10 comprises a core 12 surrounded by cladding 14. The refractive index of the cladding 14 is lower than the refractive index of the core 12. As a result, light introduced into the core 12 of the waveguide 10 is totally internally refracted at the core/cladding boundary such that the light is propagated through the length of the waveguide 10.

Although the waveguide 10 may be separately manufactured, in the illustrated example, the waveguide 10 is manufactured along with many other waveguides as part of a waveguide sheet or wafer (not shown). Thus, although in the following description is it assumed that the waveguide 10 is initially formed as part of a waveguide sheet including many waveguides, persons of ordinary skill in the art will readily appreciate that the following description and the methods it discusses apply equally well to manufacturing a single waveguide created apart from a waveguide sheet.

The waveguides 10 in the waveguide sheet may be constructed using any desired material (e.g., a polymer) and any desired manufacturing technique. The manufacturing technique(s) and material(s) used to form the waveguide(s) and/or the waveguide sheet are immaterial to this disclosure and will not be discussed further herein.

Once the waveguide sheet is formed, it is spin coated with an adhesive solution to place an adhesive solution layer 16 on a surface of the waveguide(s) 10 and/or the waveguide sheet as shown in FIG. 2. The spin coating process may be performed in a conventional manner using a conventional spin coating device. The adhesive solution layer 16 is then dried or cured to form a substantially uniform, solid or semi-solid adhesive layer 18 on the waveguide(s) 10 and/or the waveguide sheet as shown in FIG. 3.

Two example methods of forming the solid or semi-solid adhesive layer 18 will now be described. In an example approach, the adhesive solution includes a solid epoxy resin and a solid hardener that are dissolved into a solvent to form the solution. After the adhesive solution is spin coated onto the waveguide(s) 10 and/or the waveguide sheet, the waveguide(s) 10 and/or the waveguide sheet are soft baked. Because the solvent has a relatively low boiling point as compared to the solid epoxy resin and the solid hardener, soft baking the waveguide(s) 10 and/or the waveguide sheet vaporizes the solvent to thereby remove the solvent from the adhesive solution. Removing the solvent leaves a substantially uniform, solid epoxy resin-hardener layer 18 on the waveguide(s) 10 and/or the waveguide sheet as shown in FIG. 3. In the illustrated example, the solid epoxy resin-hardener layer 18 is a solid or semi-solid adhesive film 18. Preferably, the adhesive layer 18 is not tacky and, thus, the waveguide(s) 10 and/or the waveguide sheet are easy to handle during further processing.

In the foregoing example, the solvent may be a low boiling point solvent such as toulene, xylene, and/or acetone. Also, the solid epoxy resin may be a bisphenol A type solid epoxy resin, a novolac type solid epoxy resin, and/or a multifunctional epoxy resin. Further, the solid hardener may be an amine compound, an anhydride, dicyandiamide, and/or a phenolic compound.

In another example approach to forming the solid or semi-solid adhesive layer 18, the adhesive solution comprises a liquid mixture of a liquid epoxy resin and a liquid hardener. This adhesive solution is spin coated onto the waveguide sheet as explained above to form an adhesive solution layer 16 on the waveguide(s) 10 and/or the waveguide sheet as shown in FIG. 2. The liquid adhesive solution layer 16 is then partially cured to form a substantially uniform, semi-solid B-stage adhesive layer on the waveguide(s) 10 and/or the waveguide sheet as shown in FIG. 3). Preferably, the semi-solid B-stage adhesive film layer 18 is not tacky and, thus, the waveguide(s) 10 and/or the waveguide sheet are easy to handle during further processing.

In the foregoing example, the liquid epoxy may be a bisphenol A type liquid epoxy, a bisphenol F type liquid epoxy, a novolac type liquid epoxy, and/or a multifunctional epoxy resin. Also the liquid hardener may be an amine compound or an anhydride.

After the solid or semi-solid adhesive film 18 is formed, the waveguide sheet is processed to create waveguides 10 of desired dimensions and geometries. For example, the waveguide sheet may be laser cut to form a plurality of waveguides 10 having different or identical lengths, shapes, mirrors, etc. As an example, the waveguide 10 is shown in FIG. 4 as having been cleaved to form an end mirror 19. However, persons of ordinary skill in the art will readily appreciate that the processing of the waveguide sheet can be performed in any desired manner to create any desired type and or shape of waveguide. Each waveguide 10 will, however, preferably be formed such that at least some of the portion of the adhesive layer 18 associated with the waveguide 10 is positioned on a surface that is intended for mounting the waveguide 10 to a substrate. Again, because the adhesive layer 18 is preferably solid or at least semi-solid, it does not interfere with the processing of the waveguide sheet into the waveguides 10.

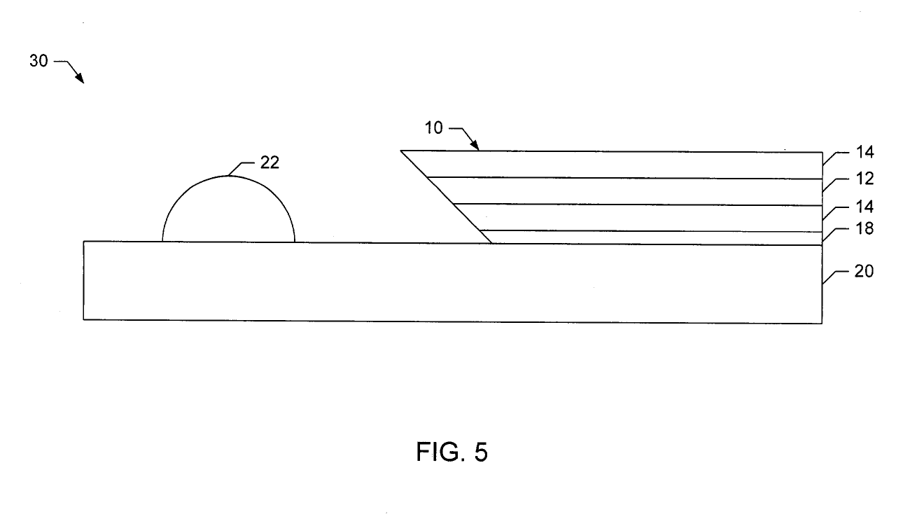

To mount one of the waveguides 10 to a substrate 20 (see FIG. 5) such as a printed circuit board, the substrate 20 is heated to a temperature above the melting point of the adhesive layer 18. A waveguide 10 is then picked-up, aligned, and positioned at a desired location on the substrate 20. This picking and placing operation may be performed manually or automatically. For example, the pick-and-placement operation to position a waveguide 10 on a substrate 20 may be performed by a conventional pick-and-place machine with machine vision. The pick-and-place machine may be provided with a heating station to heat the substrate 20 before the waveguide 10 is placed thereon.

Because the substrate 20 has a temperature above the melting point of the adhesive layer 18, when the waveguide 10 is placed on the substrate 20, the adhesive layer 18 will at least partially melt. As a result, the adhesive layer becomes tacky and then snap cures to hold the waveguide 10 on the substrate 20 in the position in which it was placed thereby preventing excessive spreading of the adhesive. The substrate 20 and the attached waveguide(s) 10 are then placed in a batch oven (possibly with other substrate/waveguide combinations) where they are baked to fully cure the adhesive layer 18 to thereby permanently affix the waveguide 10 to the substrate 20.

As shown in the example of FIG. 5, because the adhesive layer 18 is solid or semi-solid when the waveguide 10 is positioned on the substrate 20, the adhesive layer 18 does not spread out to an undesirable degree to cover adjacent structures such as solder pads 22.

From the foregoing, persons of ordinary skill in the art will appreciate that waveguide assemblies, waveguides, waveguide sheets, and methods to manufacture waveguide assemblies, waveguide sheets and/or waveguides have been disclosed. Example waveguide sheets and/or waveguides manufactured by the example methods may have a surface which is coated with a solid or semi-solid adhesive layer 18 that has a melting point above room temperature and is not tacky at room temperature. As a result, the example waveguide sheets and/or waveguides may be easily handled during further processing. For example, the waveguides may be easily handled during placement on a substrate 20. Therefore, waveguide assemblies 30 may be manufactured without dispensing liquid adhesive. Consequently, the example methods disclosed herein are compatible with low cost, high volume manufacturing techniques, and can help to achieve high throughput.

Although certain example methods and apparatus have been described herein, the scope of coverage of this patent is not limited thereto. On the contrary, this patent covers all methods, apparatus and articles of manufacture fairly falling within the scope of the appended claims either literally or under the doctrine of equivalents.

What is claimed is:

1. A method of manufacturing a waveguide assembly comprising:
coating a surface of a waveguide with an adhesive layer;
heating a substrate to a temperature above a melting point of the adhesive layer;
placing the waveguide on the heated substrate when the adhesive layer is solid or semi-solid; and
curing the adhesive layer.

2. A method as defined in claim 1 wherein coating a surface of the waveguide comprises spin coating a waveguide sheet with an adhesive solution.

3. A method as defined in claim 2 further comprising processing the waveguide sheet to form the waveguide.

4. A method as defined in claim 1 wherein coating the surface of the waveguide comprises spin coating the surface of the waveguide with an adhesive solution.

5. A method as defined in claim 4 wherein the adhesive solution comprises a solvent, a solid epoxy, and a hardener.

6. A method as defined in claim 5 further comprising vaporizing the solvent from the adhesive solution coating the surface of the waveguide sheet to form the adhesive layer.

7. A method as defined in claim 6 wherein vaporizing the solvent comprises soft baking the adhesive solution coating the surface of the waveguide sheet to remove the solvent.

8. A method as defined in claim 5 wherein the solvent comprises toluene, xylene, or acetone.

9. A method as defined in claim 5 wherein the solid epoxy comprises a bisphenol A type resin, a novolac type resin, a biphenyl type resin, or a multifunctional epoxy resin.

10. A method as defined in claim 5 wherein the hardener comprises an amine compound, an anhydride, dicyandiamide, or a phenolic compound.

11. A method as defined in claim 4 wherein the adhesive solution comprises a liquid epoxy resin and a liquid hardener.

12. A method as defined in claim 11 wherein coating a surface of the waveguide further comprises partially curing the adhesive solution to form a solid or semi-solid adhesive layer on the waveguide.

13. A method as defined in claim 11 wherein the liquid epoxy resin comprises a bisphenol A type resin, a bisphenol F type resin, a novolac resin, or a multifunctional epoxy resin.

14. A method as defined in claim 11 wherein the liquid hardener comprises an amine compound or an anhydride.

15. A method as defined in claim 1 wherein placing the waveguide on the heated substrate comprises at least partially melting the adhesive layer to tack the waveguide on the substrate.

16. A method as defined in claim 1 wherein placing the waveguide on the substrate is performed by a pick-and-place machine.

17. A method of manufacturing comprising:
coating a surface of a waveguide sheet with an adhesive solution;
at least partially drying the adhesive solution to form a solid or semi-solid adhesive layer on the waveguide sheet;
processing the waveguide sheet to form a first waveguide and a second waveguide;
heating a first substrate to a temperature above a melting point of the adhesive layer;
placing the first waveguide on the heated first substrate to tack the first waveguide in a desired location;
heating a second substrate to a temperature above the melting point of the adhesive layer;
placing the second waveguide on the heated second substrate to tack the second waveguide in a desired location; and
heating the first and second substrates in a batch oven to cure the adhesive layer.

18. A method as defined in claim 17 wherein coating the surface of the waveguide sheet comprises spin coating the waveguide sheet with the adhesive solution.

19. A method as defined in claim 17 wherein the adhesive solution comprises a solvent, a solid epoxy, and a hardener.

20. A method as defined in claim 19 wherein at least partially drying the adhesive solution to form the adhesive layer on the waveguide sheet further comprises vaporizing the solvent from the adhesive solution.

21. A method as defined in claim 20 wherein vaporizing the solvent comprises soft baking the adhesive solution to remove the solvent.

22. A method as defined in claim 19 wherein the solvent comprises toluene, xylene, or acetone.

23. A method as defined in claim 19 wherein the solid epoxy comprises a bisphenol A type resin, a novolac type resin, a biphenyl type resin, or a multifunctional epoxy resin.

24. A method as defined in claim 19 wherein the hardener comprises an amine compound, an anhydride, dicyandiamide, or a phenolic compound.

25. A method as defined in claim 17 wherein the adhesive solution comprises a liquid epoxy resin and a liquid hardener.

26. A method as defined in claim 25 wherein at least partially drying the adhesive solution to form the adhesive layer on the waveguide sheet further comprises partially curing the adhesive solution to form the adhesive layer.

27. A method as defined in claim 25 wherein the liquid epoxy resin comprises a bisphenol A type resin, a bisphenol F type resin, a novolac resin, or a multifunctional epoxy resin.

28. A method as defined in claim 25 wherein the liquid hardener comprises an amine compound or an anhydride.

29. An article of manufacture comprising:
a waveguide having a surface; and
a solid or semi-solid adhesive layer coating the surface, the adhesive layer having a melting point above room temperature such that the adhesive layer is not tacky at room temperature.

30. An article of manufacture as defined in claim 29 wherein the adhesive solution is formed from an adhesive solution comprising a solvent, a solid epoxy, and a hardener.

31. An article of manufacture as defined in claim 29 wherein the adhesive solution is formed from an adhesive solution comprising a liquid epoxy resin and a liquid hardener.

32. An article of manufacture as defined in claim 29 further comprising a substrate, the waveguide being secured to the substrate.

33. An article of manufacture comprising:
a waveguide sheet having a surface; and
a solid or semi-solid adhesive layer coating the surface, the adhesive layer having a melting point above room temperature such that the adhesive layer is not tacky at room temperature.

34. An article of manufacture as defined in claim 33 wherein the adhesive solution is formed from an adhesive solution comprising a solvent, a solid epoxy, and a hardener.

35. An article of manufacture as defined in claim 33 wherein the adhesive solution is formed from an adhesive solution comprising a liquid epoxy resin and a liquid hardener.
